(19) United States
(12) Patent Application Publication
(10) Pub. No.: US 2003/0142076 A1
(43) Pub. Date: Jul. 31, 2003

(54) New office mouse design

(75) Inventor: Tzu-Hsiang Yen, Taipei Hsien (TW)

Correspondence Address: BACON & THOMAS, PLLC, 625 SLATERS LANE, FOURTH FLOOR, ALEXANDRIA, VA, 22314

(73) Assignee: CHIC TECHNOLOGY CORP., Chung-Ho City (TW)

(21) Appl. No.: 10/316,055

(22) Filed: Dec. 11, 2002

(30) Foreign Application Priority Data
Jan. 31, 2002 (TW) 091101713

(51) Int. Cl. G09G 5/08

(52) U.S. Cl. 345/163

(57) ABSTRACT

The present invention relates to a new office mouse design especially using a mouse button to activate, open files and edit or design a completely new function of MicroSoft Office software series. The new office mouse comprises of five-buttons mouse or a common mouse wherein the activating button is the middle button of the five-buttons mouse, the special left button consists of the file opening button, the special right button consists of the editing or designing button; or specially design in advance the expansion key of a common mouse key with a menu selection function. Hence, the new practical use of the present invention provides a convenient, rapid, approachable and relaxing operation and simultaneously, increases value of the mouse products.

### TECHNICAL RANGE

The present invention relates to a new office mouse design especially using a mouse key to activate, open files and edit or design a completely new function of MicroSoft Office software series.

### INVENTION BACKGROUND

Nowadays, MicroSoft Office is certainly the most commonly used software in files editing. In order to provide a more convenient use of Office, we have put our view in the use of the mouse for convenient and relaxing use of MicroSoft Office software.

### SUMMARY OF INVENTION

The present invention relates to a new office mouse design enabling MicroSoft Office software users to easily activate the mouse buttons by simply pressing the buttons as if switching on a light.

The present invention relates to a practical use of new office mouse design wherein the third button in the middle consists of the activating button for Office software series. The special left button consists of the file opening button and the special right button of the editing or designing button.

The present invention relates to another practical use of new office mouse design wherein apart from the standard five-buttons mouse mentioned above, the expansion key of a common mouse is specially designed in advance as a special button for opening of menu selection.

### ILLUSTRATIONS OF DRAWINGS

FIG. 1 shows a view of the middle button of the five-buttons mouse.

FIG. 2 shows a view of the special left button of the five-buttons mouse.

FIG. 3 shows a view of the special right button of the five-buttons mouse.

### NUMERICALS

10—five-buttons mouse 11—left button 12—right button

13—middle button 14—special left button

15—special right button

### MODE FOR CARRYING OUT INVENTION

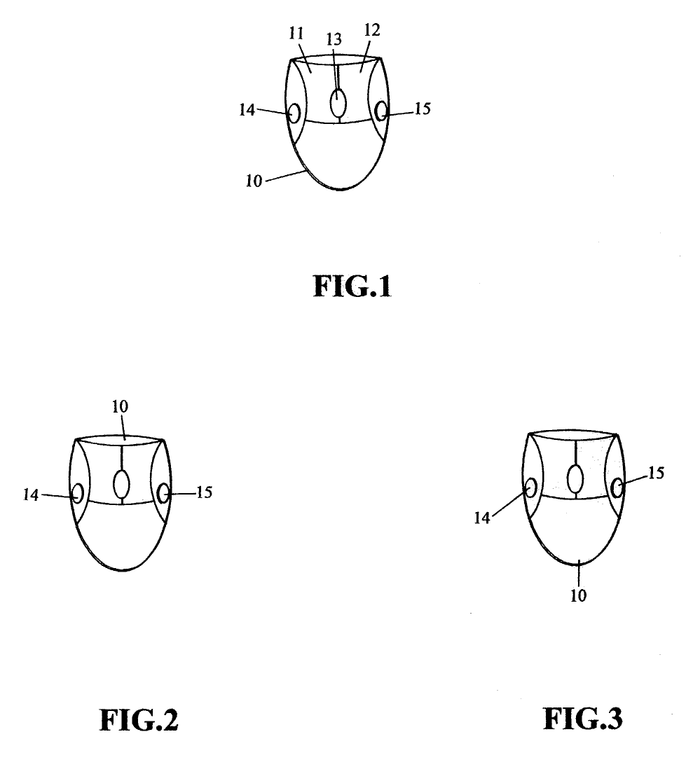

The present invention can be used in two different ways and with reference to FIGS. 1 to 3 showing a view of the five-buttons mouse, the middle button 13 of the five-buttons mouse 10 is designed to activate Office software series, special left button 14 is used to open files and special right button 15 is used for editing and designing. For any other way, a fixed process should be designed if the five-buttons mouse or a common mouse is being used such as: enter Windows→insert Office Mouse→install Driver and Application→press special button (apart from the expansion key of the 5-buttons mouse)→open menu selection function (when opening menu selection function, different menus are opened according to different situations)→select item to complete work.

With further reference to FIGS. 1 to 3, when the middle button 13 of the five-buttons mouse 10 is pressed, a choice list of MicroSoft Office software series consisting of Word, Excel, PowerPoint, Access, FrontPage, Outlook and so on will appear on the screen. When the special left button 14 pressed, it will activate opening of new files, old files, save files, save new files, preview, printing, over and other menu selections. When the special right button 15 is pressed, the choice list will differ according to the choice list of Office software as follows: when special right button 15 is pressed after opening Outlook software, a choice list consisting of (Undo), (Redo), (Reply), (Fwd), (Send)/(Receive), (Help) and so on will appear and when Word, Excel, Access, PowerPoint, FrontPage is opened, a choice list of (Undo), (Redo), Internet Webside, (MicroSoft Office Website), insert table, character size, character color, insert, paragraph setting, description, (Help) . . . and so on. Hence, mode 1 is mainly used for Office series products convenient for editing and only using a five-buttons mouse.

Another mode of carrying present invention is when Windows is opened and the expansion key of a common mouse is pressed (designed with a common mouse key with one button or one button of expansion key as special key), a choice list of MicroSoft Office software consisting of Word, Excel, PowerPoint, Outlook and so on will appear. A different choice list will then appear according to software chosen. For example, if Outlook is chosen and expanding key pressed, a choice list of open new files, open old files, save files, save new files, preview, printing, over, (Undo), (Redo), (Reply), (Fwd), (Send)/(Receive), (Help), and so on. If Word, Excel is chosen and expanding key pressed, a choice list of open new files, save files, save new files, preview, printing, end insert table, character size, character color, insert, paragraph setting, (Help), and so on.

The use of software and hardware mentioned in mode 2 consist of use of Office series, easy to edit files. Work can be easily completed by simply using an Office mouse and a special button.

1. A new office mouse design using MicroSoft Office software series comprising of a mouse designed with five buttons or a common mouse, wherein:
The middle button of said five buttons consists of the activating button, the special left button consists of the opening file button, the special right button consists of the editing and designing button; or,
The expansion key of the common mouse is designed in advance as a special key for opening of choice list and item selection for completion of work, as characterized below.
